(19) United States
(12) Patent Application Publication
(10) Pub. No.: US 2010/0266764 A1
(43) Pub. Date: Oct. 21, 2010

(54) METHOD AND COMPOSITION SUITABLE FOR COATING DRINKING WATER PIPELINES

(75) Inventors: Ian Robinson, Northallerton (GB); Stuart E. Fores, Darlington (GB); Michael J. Kochanewycz, Darlington (GB)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/756,274

(22) Filed: Apr. 8, 2010

Related U.S. Application Data
(60) Provisional application No. 61/169,868, filed on Apr. 16, 2009.

(51) Int. Cl. B05D 7/22; C09D 5/00; C09D 175/00; B05D 1/02

(52) U.S. Cl. 427/236; 106/287.25; 524/590; 427/422

(57) ABSTRACT

Methods of forming a coating on (e.g. internal) surfaces of a (e.g. drinking water) pipeline with two-part coating compositions comprising a first part comprising at least one polyisocyanate and a second part comprising at least one aspartic acid ester. Also described is a reactive two-part coating composition comprises a first part comprising at least one polyisocyanate; and a second part comprising at least one aspartic acid ester and at least one aromatic amine that is a solid at 25° C.

### RELATED APPLICATION DATA

This application claims the benefit of U.S. Provisional Application Ser. No. 61/169,868, filed Apr. 16, 2009.

### BACKGROUND

Trenchless methods for structural renovation of drinking water pipelines include the pipe in pipe method, pipe bursting method, and polyethylene thin wall lining method. As described in U.S. Pat. No. 7,189,429, these methods are disadvantaged by their inability to deal with multiple bends in a pipeline and the fact that lateral connection pipes to customers' premises have to be disconnected and then reinstated after execution of the renovation process.

U.S. Pat. No. 7,189,429 describes a method of forming a coating on the internal surface of a drinking water pipeline, the method comprising the steps of: a) providing a liquid, two-part coating system; b) mixing together the first part and the second part to form a mixture, and c) applying the mixture as a coating to said surface so as to form, at high cure rate, a monolithic lining which exhibits high strength and flexibility. Preferably the two parts of the system are applied through heated airless spray equipment. Such equipment may, for example, include a centrifugal spinning head or a self-mixing spray gun assembly.

U.S. Pat. No. 6,730,353 describes a coating for drinking water pipelines. The two-part coating system comprises a first part comprising one or more aliphatic polyisocyanates, optionally blended with one or more amine reactive resins and/or non reactive resins, and a second part comprising one or more aromatic polyamines optionally blended with one or more oligomeric polyamines, such that the two parts, when mixed together and applied to the internal surfaces of pipelines, form a rapid setting impervious coating suitable for contact with drinking water.

Different municipalities have different requirements for drinking water pipelines. For example, in the United Kingdom, coatings for drinking water pipelines are subject to compliance with Regulation 31 of the Water Supply (Water Quality) Regulations; whereas in the United States coatings for drinking water pipelines require compliance with NSF/ANSI Standard 61.

### SUMMARY

The present invention describes methods of forming a coating on surfaces of a (e.g. drinking water) pipeline and two-part coating compositions.

In one embodiment, the method comprises the steps of: a) providing a coating composition comprising a first part comprising at least one polyisocyanate, and a second part comprising at least one aspartic acid ester; b) combining the first part and the second part to form a liquid mixture; c) applying the liquid mixture to internal surfaces of a pipeline; and d) allowing the mixture to set forming a cured coating. The method is particularly amenable for refurbishing drinking water pipeline wherein the cured coating comes in contact with the drinking water.

In another embodiment, a method of lining a surface of a (e.g. service) pipeline is described. The method comprises a) providing a coating composition by combining a first part comprising at least one polyisocyanate, and a second part comprising at least one polyamine, wherein the coating has a set time of about 3 to 6 minutes; b) combining the first part and the second part to form a liquid mixture; c) applying the liquid mixture to internal surfaces of a pipeline having an internal diameter of less than 50 mm for a length of at least 5 meters; and d) allowing the mixture to set forming a cured continuous lining. The coating is preferably applied for a length of at least 10, 15 or 20 meters before the coating has set. A preferred coating comprises at least one aspartic acid ester as a component of the second part.

In other embodiments, reactive two-part coating compositions are described comprising a first part comprising at least one polyisocyanate; and a second part comprising at least one aspartic acid ester and at least one aromatic amine that is a solid at 25° C. One suitable aromatic amine is an alkyl aniline such as 4,4′-methylenebis(2,6-diisopropylaniline).

Coating compositions suitable for coating internal surfaces of drinking water pipeline are typically prepared from one or more aliphatic polymeric polyisocyanate(s) that are substantially free of isocyanate monomer such as derivatives of hexamethylene diisocyanate. Two-part compositions described herein are believed to comply with the requirements of NSF/ANSI Standard 61-2008.

### DETAILED DESCRIPTION

The present invention provides a two-part coating system that can be applied to internal pipeline surfaces so as to form, at a high cure rate, an impervious lining suitable for contact with drinking water. By virtue of its rapid setting characteristics and insensitivity to moisture, the system of the present invention is particularly useful as an “in-situ” applied lining for refurbishment of existing drinking water pipelines.

The first part of the two-part coating composition generally comprises at least one polyisocyanate and the second part comprises at least one polyamine. After application and curing, the coating composition comprises the reaction product of such first and second components. The reacted coating comprises urea groups (—NR—C(O)—NR—). Polymers containing urea groups are often referred to as polyureas. When the two-part coating composition comprises other isocyanate reactive or amine reactive components, the reacted coating may comprise other groups as well.

The first part of the two-part coating comprises one or more polyisocyanates. “Polyisocyanate” refers to any organic compound that has two or more reactive isocyanate (—NCO) groups in a single molecule such as diisocyanates, triisocyanates, tetraisocyanates, etc., and mixtures thereof. Cyclic and/or linear polyisocyanate molecules may usefully be employed. The polyisocyanate(s) of the isocyanate component are preferably aliphatic.

Suitable aliphatic polyisocyanates include derivatives of hexamethylene-1,6-diisocyanate; 2,2,4-trimethylhexamethylene diisocyanate; isophorone diisocyanate; and 4,4′-dicyclohexylmethane diisocyanate. Alternatively, reaction products or prepolymers of aliphatic polyisocyanates may be utilized.

The first part preferably comprises one or more derivatives of hexamethylene-1,6-diisocyanate (HDI). The polyisocyanate preferably comprises an uretdione, biuret, and/or isocyanurate of HDI. One type of HDI uretdione polyisocyanate, is available from Bayer Corporation under the trade designation “Desmodur N 3400”. This material is reported to have a viscosity of about 140 mPas at 25° C. Another low viscosity polyisocyanate HDI trimer, reported to have a viscosity of about 1100 mPas at 23° C. is available from Bayer Corp. under the trade designation “Desmodur N 3600”. Such polyisocyanates typically have an isocyanate content of 20-25%. Another low viscosity polyisocyanate prepolymer resin based on HDI, reported to have a viscosity of 700 mPas at 23° C. is available from Bayer Corp. under the trade designation “Desmodur XP 2599”. Preferred aliphatic polyisocyanate are solvent-free and are substantially free of isocyanate (HDI) monomer, i.e. less than 0.5% and more preferably no greater than 0.3% as measured according to DIN EN ISO 10 283.

In some embodiments, the first part consists essentially of a single aliphatic polyisocyanate comprising HD' uretdione groups such as “Desmodur 3400”. Such composition is suitable for small diameter pipes wherein flexibility (e.g. % elongation of at least 50%) is not required. To enhance the flexibility, the first part typically comprises a mixture of aliphatic polyisocyantes. In some embodiments, the first part comprises a mixture of an aliphatic polyisocyanate comprising HDI uretdione groups such as “Desmodur N 3400” in combination with a low viscosity polyisocyanate prepolymer resin based on HDI such as “Desmodur XP 2599” at a weight ratio ranging from about 4:1 to 1:4 with a ratio of 4:1 to 1:1 being preferred. In other embodiments, the first part comprises a mixture of a polyisocyanate HDI trimer such as “Desmodur N 3600” in combination with a low viscosity polyisocyanate prepolymer resin based on HDI such as “Desmodur XP 2599” at a weight ratio ranging from about 1:4 to 4:1 with a ratio of about 1:1 being preferred. In yet other embodiments, the first part comprises a mixture of all three of such HDI derivatives, wherein each of these isocyanate components are present in an amount ranging from about 10, 15 or 20 wt-% solids to about 40, 50 or 60 wt-% solids with the proviso that the sum of the amounts of the derivatives equals 100%.

In preferred embodiments for water distribution pipes, wherein flexibility is important, the first part comprises a low viscosity polyisocyanate resin based on HDI such as “Desmodur XP 2599” in an amount of about 30-45 wt-% solids; a polyisocyanate HDI trimer such as “Desmodur N 3600” in an amount about equal to or up to 10 wt-% less than the amount of low viscosity polyisocyanate; and about 10-30 wt-% solids of an aliphatic polyisocyanate comprising HDI uretdione groups such as “Desmodur N 3400”.

The first part may optionally further comprise non-reactive resins and/or other “amine reactive resin(s)” i.e. a resin containing functional groups capable of reacting with primary or secondary amines. Useful materials include epoxy functional compounds and compounds containing unsaturated carbon-carbon bonds capable of undergoing “Michael Addition” with polyamines, (e.g. monomeric or oligomeric polyacrylates).

In some embodiments, the first part comprises at least 0.5 wt-% and no greater than about 5 wt-% of a liquid epoxy resin for the purpose of facilitating the dispersion of pigment during manufacture. In other embodiments, such as when the composition is intended for application to smaller internal diameter pipes, the first part may comprise up to about 25 wt-% of liquid epoxy resin for the purpose of reducing the heat of reaction and potential shrinkage of the coating during application and curing, with 10 wt-% to 20 wt-% generally being preferred.

Various liquid epoxy resins are known. Epoxy resins contain a reactive oxirane structure that is commonly referred to as “epoxy” functionality. The simplest epoxy resin is a diglycidyl ether of bisphenol A (DGEBA), derived from the reaction of bisphenol A and epichlorohydrin. Such liquid epoxy resin is commercially available from Dow under the trade designation “D.E.R. 331”, reported to have an epoxy equivalent weight range of 182-192, a viscosity of 11,000 to 14,000 cps at 25° C. and are free from —OH reactive sites.

The second part of the two part coating comprises one or more polyamines. As used herein, polyamine refers to compounds having at least two amine groups, each containing at least one active hydrogen (N—H group) selected from primary amine or secondary amine. In some embodiments, the second component comprises or consists solely of one or more secondary amines.

In a preferred coating composition, as described herein the amine component comprises at least one aspartic acid ester. Such aspartic acid esters are polyfunctional.

Preferred aspartic ester amines have the following Formula I

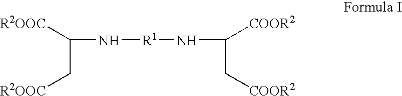

wherein R¹ is a divalent organic group (up to 40 carbon atoms), and each R² is independently an organic group inert toward isocyanate groups at temperatures of 100° C. or less.

In the above formula, preferably, R¹ is an aliphatic group (preferably, having 1-20 carbon atoms), which can be branched, unbranched, or cyclic. More preferably, R¹ is selected from the group of divalent hydrocarbon groups obtained by the removal of the amino groups from 1,4-diaminobutane, 1,6-diaminohexane, 2,2,4- and 2,4,4-trimethyl-1,6-diaminohexane, 1-amino-3,3,5-trimethyl-5-aminomethyl-cyclohexane, 4,4′-diamino-dicyclohexyl methane or 3,3-dimethyl-4,4′-diamino-dicyclohexyl methane.

In some embodiments, R¹ preferably comprises a dicyclohexyl methane group or a branched C4 to C12 group. R² is typically independently a lower alkyl group (having 1-4 carbon atoms).

Suitable aspartic acid esters are commercially available from Bayer Corp. under the trade designations “Desmophen NH 1420”, “Desmophen NH 1520” and “Desmophen NH 1220”.

Desmophen NH 1420 is substantially composed of the following compound Formula II;

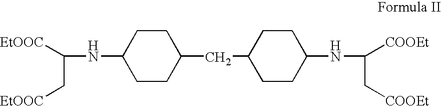

Desmophen NH1520 is substantially composed of the following compound Formula III;

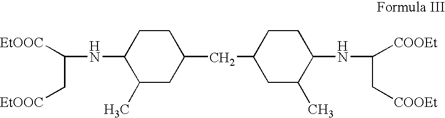

Desmophen NH 1220 is substantially composed of the following compound Formula IV;

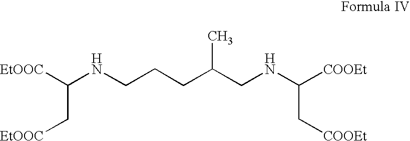

wherein in each of Formulas II-IV, Et is ethyl.

The inclusion of aspartic acid esters according to Formula I wherein R¹ is a branched or unbranched group lacking cyclic structures and having less than 12, 10, 8, or 6 carbon atoms, such as depicted in Formula IV, is typically preferred for faster film set times of 2 to 5 minutes. The inclusion of an aspartic acid ester according to Formula I wherein R¹ is comprises unsubstituted cyclic structures, such as depicted in Formula II, can be employed to extend the film set time to 5 to 10 minutes. The inclusion of an aspartic acid ester according to Formula I wherein R¹ comprises substituted cyclic structures, such as depicted in Formula III, can even further extend the film set time. Typically, such aspartic acid ester are employed at only small concentrations is combination with another aspartic acid ester that provides faster film set times, as just described.

The aspartic ester amine is typically combined with one or more secondary cycloaliphatic or aromatic polyamines for the purposes of adjusting the set time of the composition and adjusting the mechanical properties of the cured composition. In some embodiments, the coating composition further comprises at least one aromatic polyamine that is a solid at ambient temperature (25° C.). Suitable solid aromatic polyamines include alkyl anilines such as 4,4′-methylenebis(2-isopropyl-6-methylaniline) commercially available from Lonza under the trade designation “Lonzacure M-MIPA”; 4,4′-methylenebis(2,6-diisopropylaniline) commercially available from Lonza under the trade designation “Lonzacure M-DIPA”; 4,4′-methylenebis(2-ethyl-6-methylaniline); and 4,4′-methylenebis(3-chloro-2,6-diethylaniline) commercially available from Lonza under the trade designation “Lonzacure MCDEA”.

The aspartic acid ester and aromatic polyamine are chosen such that the aromatic polyamine is dissolved in the liquid aspartic acid ester. Aspartic acid esters, such as Desmophen 1220, can exhibit high solvency for solid aromatic amines. In some embodiments, up to about 50 wt-% of a solid aromatic amine such as an alkyl aniline can be dissolved in the aspartic acid ester. In other embodiments, the second part comprises at least about 5 or 10 wt-% and typically no greater than 15 wt-% of a solid aromatic amine or a cycloaliphatic secondary amine.

A wide range of formulations are possible, such as exemplified in the forthcoming examples, depending on the desired mechanical properties and set time of the coating. The preferred properties of the coating composition can depend on the type of water pipeline. For coating compositions for water distribution pipes, typically having a diameter≧3 inches (7.6 cm) up to about 12 inches (30 cm), it is generally desired that the cured coating has sufficient toughness (i.e. flexural strength) and ductility (i.e. flexibility as characterized by elongation at break) to remain continuous in the event of a subsequent circumferential fracture of a partially deteriorated (e.g. cast iron) pipe such that the cured coating continues to provide a water impervious barrier between the flowing water and internal surfaces of the pipe. The following table describes typical and preferred properties of cured coating compositions for water distribution pipes as determined by the test methods described in the examples.

| | | More Preferred |
|---|---|---|
| Physical Properties | Preferred Property | Property Range |
| Coating Thickness | 1-6 mm | 3-4 mm |
| Film Set Time | 2-3 minutes | |
| Tensile Strength (MPa) | 12-30 MPa | 15-25 MPa |
| Test Method: BS EN | | |
| ISO 527:1996 or ASTM D638 | | |
| Elongation at Break (%) | 30-50% to 125 150% | 60-90% |
| Test Method: BS EN | | |
| ISO 527:1996 or ASTM D638 | | |
| Flexural Strength (MPa) | 10 to 20-30 MPa | 15-25% |
| Test Method: BS EN | | |
| ISO 178:1997 or ASTM D790 | | |
| Flexural Modulus (MPa) | 600-800 Mpa | |
| Test Method: BS EN | | |
| ISO 178:1997 or ASTM D790 | | |
| Hardness | 60-80 Shore D | 65-75 Shore D |
| Test Method: ASTMD2240 | | |
| Impact Resistance | at least 9 J | at least 18 J |
| 120 mil (3 mm) | | |
| film thickness | | |
| Test Method: ASTM D2784 | | |
| Abrasion Resistance | 60-80 mgm/1000 cycles | |
| Test Method: ASTM D4060 | (CS17 wheel, 1 kg load) | |
| Glass Transition Temperature | 25° C. to 80° C. | |
| (Tg) | | |
| Test Method ASTM D7028 | | |
| Coefficeint of | less than 200 ppm | |
| Thermal Expansion | | |
| Test Method: ASTM D696 | | |
| Water Absorption | less than 2% | |
| Test Method: ASTM | | |
| D-570-98 | | |

In order to be utilized in a commercial capacity, the pipeline coating compositions are subject to compliance with various regulations. Different municipalities have different requirements for drinking water pipelines. The pipeline coating compositions described herein have been found to comply with NSF/ANSI Standard 61-2008 (i.e. the standard for the United States) and are also believed to comply with Regulation 31 of the Water Supply (Water Quality) Regulations (i.e. the standard for the United Kingdom).

The pipeline coatings have also been found to pass Cast Iron Pipe Testing, as conducted by Exova (UK) technical work procedure MTET-D/M11 Procedure for Static and Dynamic Strength of Components and Structures. The cured coating compositions were found to be intact after testing.

For smaller diameter (e.g. lead service) pipes having a diameter less than 3 or 2 inches, the cured coating may solely provide a water impervious lining on the internal surfaces of the pipe. The thickness of the coating it typically at least 0.5 mm and no greater than 2 mm Hence, the mechanical properties (e.g. tensile strength) and well as flexibility (i.e. elongation) are generally not required. Further, the set time of the coating composition is preferably in the range of 3 to 6 minutes, rather than approximately 2 to 3 minute which is more typical for water distribution pipes.

The first and/or second part may comprise up to 50 wt-% of a filler. In some embodiments, a filler such as calcium magnesium carbonate is employed at a concentration of 10 wt-% to 30 wt-%. A filler is a solid, insoluble material often employed to add bulk volume or to extend the pigments capabilities without impairing the reactive chemistry of the coating mixture. Unlike pigments that have desirable optical properties and are often relatively expensive, fillers typically do not possess such optical properties and are generally less expensive than pigments. Many fillers are natural minerals such as talc, clay, calcium carbonate, kaolin, whiting, and silica. Other exemplary fillers includes ceramic microspheres, hollow polymeric microspheres such as those available from Akzo Nobel, Duluth, Ga. under the trade designation “Expancel 551 DE”), and hollow glass microspheres (such as those commercially available from 3M Company, St. Paul, Minn. under the trade designation “K37”. Hollow glass microspheres are particularly advantageous because they demonstrate excellent thermal stability and a minimal impact on dispersion viscosity and density.

The first and/or second part may comprise various additives as are known in the art, provided the inclusion of such is permitted with the requirements of the NSF/ANSI Standard. For example, pigments, dispersing and grinding aids, water scavengers, thixotropes, defoamers, etc. can be added to improve the manufacturability, the properties during application and/or the shelf life.

The stoichiometry of the polyurea reaction is based on a ratio of equivalents of isocyanate (e.g. modified isocyanate and excess isocyanate) of the first component to equivalents of amine of the second component. The first and second components are reacted at a stoichiometric ratio of about 1:1. Preferably, the isocyanate is employed in slight excess.

The first and second parts are preferably each liquids at temperatures ranging from 5° C. to 25° C. In view of the confined spaces within the pipeline and the resultant lack of suitable outlet for vapor, both the first part and the second part are substantially free of any volatile solvent. That is to say, solidification of the system applied to the pipeline interior is not necessitated by drying or evaporation of solvent from either part of the system. To further lower the viscosity, one or both parts can be heated. Further, the coating composition has a useful shelf life of at least 6 months, more preferably, at least one year, and most preferably, at least two years.

The coating composition is typically applied directly to the internal surfaces of a pipe without a primer layer applied to the surface. This can be done using various spray coating techniques. Typically, the amine component and the isocyanate component are applied using a spraying apparatus that allows the components to combine immediately prior to exiting the apparatus. In carrying out the method of the invention, the first and second parts of the system are fed independently, e.g. by flexible hoses, to a spraying apparatus capable of being propelled through an existing pipeline to be renovated. For example, a remote controlled vehicle, such as described in US 2006/0112996, may enter the pipeline to convey the spraying apparatus through the pipeline. The apparatus preferably heats the two parts of the system prior to application to the pipeline interior and mixes the two parts immediately before applying the mixture to the interior surface of the pipeline. The mixture of the two parts cures on the interior surface of the pipeline to form a (e.g. monolithic) water impervious lining. Such linings may be formed when the pipeline is initially laid, or after a period of use when the pipeline itself begins to deteriorate.

A variety of spray systems may be employed as described in the art. In some embodiments, a heated airless spray apparatus, such as a centrifugal spinning head is employed. An airless, impingement mixing spray system generally includes the following components: a proportioning section which meters the two components and increases the pressure to above about 1500 psi (10.34 MPa); a heating section to raise the temperatures of the two components (preferably, independently) to control viscosity; and an impingement spray gun which combines the two components and allows mixing just prior to atomization.

In other embodiments, a heated air vortex spray apparatus can be used to apply the coating.

Viscosity behavior of the each of the two components is important for two part spray-coating processes. With impingement mixing, the two parts should be as close as possible in viscosity at high shear rates to allow adequate mixing and even cure. The plural component static mix/spray system appears to be more forgiving of viscosity differences between the two components. Characterization of viscosities as functions of shear rate and temperature can help with decisions as to starting point for temperatures and pressures of the coatings in the two part spray equipment lines.

Objects and advantages of the invention are further illustrated by the following examples, but the particular materials and amounts thereof recited in the examples, as well as other conditions and details, should not be construed to unduly limit the invention. All percentages and ratios herein are by weight unless otherwise specified

### EXAMPLES

The following Table describes the chemical description, trade designation, and supplier of the components employed in the coating compositions of the examples.

| | | |
|---|---|---|
| Chemical Description | Trade Designation | Supplier |

Polyisocyanates

| | | |
|---|---|---|
| Aliphatic Polyisocyanate | Desmodur XP2599 | Bayer |
| Aliphatic Polyisocyanate | Desmodur N3600 | Bayer |
| Aliphatic Polyisocyanate | Desmodur N3400 | Bayer |

Aspartic acid esters

| | | |
|---|---|---|
| Formula II as previously | Desmophen NH 1420 | Bayer |
| described | | |
| Formula IV as previously | Desmophen NH 1220 | Bayer |
| described | | |

Other Reactive Components

| | | |
|---|---|---|
| Liquid Epoxy Resin - | DER331 | Dow |
| diglycidyl ether of | | |
| bisphenol-A | | |
| 4,4′-Methylenebis(2,6- | Lonzacure m-DIPA | Lonza |
| diisopropylaniline) | | |
| Cycloaliphatic secondary | BAXXODUR PC-136 | BASF |
| polyamine | | |

Additives

| | | |
|---|---|---|
| Titanium Dioxide Pigment | Tiona 595 | Millenium |
| | | Chemicals |
| Iron Oxide Pigment | Bayferrox 318M | Lanxess |
| Crystaline Aluminosilicate | Sylosiv A3 | WR Grace |
| Moisture Scavenger | | |
| Amorphous Silicon Dioxide | Cab-o-Sil TS 720 | Cabot |
| Thixotrope | | |
| Calcium Magnesium | Microdol H 600 | Omya |
| Carbonate Filler | | |

### Test Methods:

Tensile Strength and Elongation at Break—BS EN ISO 527:1996 (unless indicated otherwise)
Flexural Strength—BS EN ISO 178:1997 (unless indicated otherwise)
Film Set Time—The first and second part are combined and mixed for 30-40 seconds and then poured into a dish at a depth of 3 mm. The composition is allowed to cure in a horizontal position. While curing, a wooden spatula can gently be tapped on the surface. The time at which the spatula stops sticking to the surface is the set time.
Tensile Strength and Elongation at Break—ASTM D638-08 Tensile properties of Plastics
Equipment: Instron with Fixed Grips, 5 kN load cell; Type I Class C Extensometer used to determine Poisson's Ratio
Software: Bluehill—report Elongation and Strength
Test Specimen Type IV with a thickness of 3.3±0.1 mm, injection molded into a Teflon die
Speed of Testing: 2 in/min
Conditioning: Allowed samples to cure for 7 days in desiccator

### Flexural Strength—ASTM D790-07 Flexural Properties of Unreinforced and Reinforced Plastics and Electrical Insulating Materials

Equipment: Instron, 5 kN load cell
Software: Bluehill—report modulus and strength
Test Specimen: 120 mm×10 mm×4 mm injection molded bars (Teflon molds)

### Support Span: 64 mm

Crosshead Speed: 1.7 mm/min

### Hardness—ASTM D2240-05 Rubber Property—Durometer Hardness

### Equipment: Type D Ergo Style Analog Durometer—Model 409

### Indentor: Conical

Operating Stand: None—hand held, follow section 9.2. No additional mass used.
Conditioning: Allowed samples to cure for 7 days, test at room conditions

### Glass Transition Temperature (Tg)—ASTM D7028-07 Glass Transition Temperature (DMA Tg) of Polymer Matrix Composites by Dynamic Mechanical Analysis

### Equipment: Seiko DMS 200

### Heating Rate: 2° C./min

Conditioning: Allow samples to cure for 7 days in desiccator
Impact Resistance (120 mil (3 mm) thickness)—ASTM D2794-93 Resistance of Organic Coatings to the Effects of Rapid Deformation

### Equipment: BYK Heavy-Duty Impact Tester

### Indenter Diameter: 0.625 in

### Guide Tube: 40 in

### Weights: 2, 4, and 8 lbs.

### Test Specimen:

Substrate—4″×4″×¼″ bead blasted cold rolled steel—This is a deviation from the ASTM which calls for 24 gage steel panels treated with a conversion coating.
Coating—thickness equal to standard product application thickness (3.5 mm)
   Conditioning: Allowed samples to cure for 7 days at 23 C and 50% RH
   Failure determined using magnification.
   Copper sulfate solution and pinhole detectors were not used.

### Water Absorption—D-570-98 Water Absorption of Plastics

### Test Specimen Section 5.2—ISO Standard Specimen

Procedure: 7.1—Twenty-Four Hour Immersion in 23±1° C. DI water
Conditioning: Cured for 7 days in desiccator
Reconditioning: 7 days in desiccator
Reported average weight increase and soluble matter lost of 4 samples
Cast Iron Pipe Testing—Exova (UK) technical work procedure MTET-D/M11 Procedure for Static and Dynamic Strength of Components and Structures

The two-part coating compositions are described herein with respect to wt-% solids of the first part and wt-% solids of the second part. Each part totals 100%.

| | Example 1 | Example 2 | Example 3 |
|---|---|---|---|
| | Wt-% Solids of | Wt-% Solids of | Wt-% Solids of |
| Trade Designation | Part | Part | Part |
| First Part | | | |
| Desmodur XP2599 | 37.4 | 37.4 | 37.4 |
| Desmodur N3600 | 32.7 | 28.0 | 37.3 |
| Desmodur N3400 | 23.4 | 28.0 | 18.7 |
| DER331 | 1.4 | 1.4 | 1.4 |
| Tiona 595 | 1.1 | 1.2 | 1.2 |
| Sylosiv A3 | 0.3 | 0.3 | 0.3 |
| Cab-o-Sil TS 720 | 3.7 | 3.7 | 3.7 |
| Second Part | | | |
| Desmophen NH 1220 | 56.2 | 54.6 | 58.0 |
| Lonzacure m-DIPA | 11.9 | 13.6 | 10.2 |
| Cab-o-Sil TS 720 | 4.1 | 4.1 | 4.1 |
| Sylosiv A3 | 6.8 | 6.8 | 6.8 |
| Bayferrox 318M | 0.1 | 0.1 | 0.1 |
| Microdol H 600 | 20.8 | 20.8 | 20.8 |

Examples 1-3 comply with NSF/ANSI Standard 61-2008. Since Examples 4-16 are based on the same components, these examples are also believed to comply with the NSF/ANSI Standard 61-2008.

Physical Properties of Example 2

| Gel Time | 120 seconds |
|---|---|
| | (at a film thickness of |
| | 3.5 mm at 20° C.) |
| Film Set Time | 4 minutes |
| | (at a film thickness of |
| | 3.5 mm at 20° C.) |
| Cure Time | 10 minutes |
| Tensile Strength (MPa) | 16 MPa |
| ASTM D638 | |
| Elongation at Break (%) | 64% |
| ASTM D638 | |
| Flexural Strength (MPa) | 22 MPa |
| ASTM D790 | |
| Flexural Modulus (MPa) | 720 MPa |
| ASTM D790 | |
| Hardness | 65 Shore D |
| ASTM D2240 | |
| Impact Resistance 120 mil | >18 J |
| (3 mm) film thickness ASTM D2784 | |
| Abrasion Resistance | 71 mgm/1000 cycles |
| Test Method: ASTM D4060 | (CS17 wheel, 1 kg load) |
| Glass Transition Temperature (Tg) | 51° C. |
| Test Method ASTM D7028 | |
| Coefficeint of Thermal Expansion | 116 ppm |
| Test Method: ASTM D696 | |
| Water Absorption | 1.78% |

### Cast Iron Pipe Testing of Example 2

The composition of Example 2 was applied to the interior of a six inch cast iron pipe using a two-part pumping system, static mixer and centrifugal coating head. The nominal coating thickness of the lining formed was 3 mm. The cast iron pipe was then machined to reduce the wall thickness in the area of the advancing probe of a compression, 3 point bend test with a 900 mm span in order to reduce the load required to fracture the pipe and control the fracture location. The compression rate of the bend tester was controlled at a rate of 0.5 mm/min until pipe fracture was observed. Once the pipe fractured, the rate was increased to 3 mm/min. and displacement was carried out to designated endpoints corresponding to a 5 degree and 10 degree pipe deflection angle, respectively. Observations were then made of the interior lining. It was noted that the lining did debond from the pipe wall in the fractured pipe area but remained bonded in all other areas. The liner conformed to the fractured pipe condition and remained intact, continuous and free of cracks. This demonstrates that the lining would be capable of withstanding a transverse shear pipe fracture with deflection in field applications.

### Example 4

### Exemplary Formulation for Smaller Diameter Pipe

| Trade Designation | Wt-% Solids of Part |
|---|---|
| First part | |
| Desmodur N3400 | 56.0 |
| DER331 | 14.0 |
| Tiona 595 | 2.2 |
| Sylosiv A3 | 3.5 |
| Microdol H600 | 22.5 |
| Cab-o-Sil TS 720 | 1.8 |
| Second part | |
| Desmophen NH 1220 | 34.0 |
| Desmophen NH 1420 | 34.0 |
| Lonzacure m-DIPA | 17.0 |
| Microdol H600 | 7.1 |
| Sylosiv | 4.3 |
| Bayferrox 318M | 0.2 |
| Cab-o-Sil TS 720 | 3.4 |

| | Ex. 5 | Ex. 6 | Ex. 7 |
|---|---|---|---|
| First part | | | |
| DESMODUR XP2599 | 40.0 | 40.0 | 40.0 |
| DESMODUR N3600 | 30.0 | 35.0 | 40.0 |
| DESMODUR N3400 | 30.0 | 25.0 | 20.0 |
| Second part | | | |
| DESMOPHEN NH1220 | 80.0 | 82.5 | 85.0 |
| LONZACURE m-DIPA | 20.0 | 17.5 | 15.0 |
| Physical Properties | | | |
| Tensile Strength (MPa) | 20.4 | 18.6 | 19.5 |
| Elongation at Break (%) | 110 | 120 | 85 |
| Flexural Strength (MPa) | 16.6 | 13.5 | 16.1 |
| Film Set Time (Minutes) | 2.5 | 2.5 | 2.5 |
| | Ex. 8 | Ex. 9 | Ex. 10 |
| First part | | | |
| DESMODUR XP2599 | 40.0 | 40.0 | 40.0 |
| DESMODUR N3600 | 30.0 | 30.0 | 30.0 |
| DESMODUR N3400 | 30.0 | 30.0 | 30.0 |
| Second part | | | |
| DESMOPHEN NH1420 | 80.0 | 60.0 | 40.0 |
| DESMOPHEN NH1220 | 0 | 20.0 | 40.0 |
| LONZACURE m-DIPA | 20.0 | 20.0 | 20.0 |
| Physical Properties | | | |
| Tensile Strength (MPa) | 22.4 | 21.3 | 21.0 |
| Elongation at Break (%) | 50 | 60 | 75 |
| Flexural Strength (MPa) | 16.9 | 16.5 | 16.5 |
| Film Set Time (Minutes) | 10.0 | 7.0 | 5.5 |
| | Ex. 11 | Ex. 12 | Ex. 13 |
| First part | | | |
| DESMODUR XP2599 | 50.0 | 30.0 | 0 |
| DESMODUR N3600 | 50.0 | 0 | 0 |
| DESMODUR N3400 | 0 | 70.0 | 100.0 |
| Second part | | | |
| DESMOPHEN NH1420 | 0 | 0 | 40.0 |
| DESMOPHEN NH1220 | 80.0 | 80.0 | 40.0 |
| LONZACURE m-DIPA | 20.0 | 20.0 | 20.0 |
| Physical Properties | | | |
| Tensile Strength (MPa) | 19.1 | 19.7 | 55.5 |
| Elongation at Break (%) | 100 | 140 | 5 |
| Flexural Strength (MPa) | 16.0 | 6.9 | 66 |
| Film Set Time (Minutes) | 2.5 | 2.5 | 4.5 |
| | Ex. 14 | Ex. 15 | Ex. 16 |
| First part | | | |
| DESMODUR XP2599 | 50.0 | 50.0 | 50.0 |
| DESMODUR N3600 | 50.0 | 50.0 | 50.0 |
| Second part | | | |
| DESMOPHEN NH1220 | 92.5 | 90.0 | 87.5 |
| BAXXODUR PC-136 | 7.5 | 10.0 | 12.5 |
| Physical Properties | | | |
| Tensile Strength | 10.4 | 15.2 | 17.1 |
| Elongation at Break (%) | 150 | 120 | 100 |
| Flexural Strength (MPa) | 3.3 | 9.1 | 12.7 |
| Film Set Time (Minutes) | 3.5 | 3.0 | 2.5 |

What is claimed is:

1. A method of forming a coating on a surface of a pipeline the method comprising the steps of:
a) providing a coating composition comprising
a first part comprises at least one polyisocyanate, and
a second part comprising at least one aspartic acid ester;
b) combining the first part and the second part to form a liquid mixture;
c) applying the liquid mixture to internal surfaces of the pipeline; and
d) allowing the mixture to set forming a cured coating.

2. The method of claim 1 wherein the pipeline is a drinking water pipeline and the cured coating comes in contact with the drinking water.

3. The method of claim 2 wherein the cured coating complies with NSF/ANSI Standard 61.

4. The method of claim 1 wherein the first part comprises an aliphatic polyisocyanate that is substantially free of isocyanate monomer.

5. The method of claim 4 wherein the aliphatic isocyanate is a derivative of hexamethylene diisocyanate.

6. The method of claim 1 wherein the aspartic acid ester has the general formula 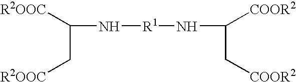
wherein R¹ is an aliphatic group comprising up to 20 carbon atoms, optionally comprising at least one cycloaliphatic group; and
each R¹ is independently a C1 to C4 aliphatic group.

7. The method of claim 6 wherein the aspartic acid ester is selected from 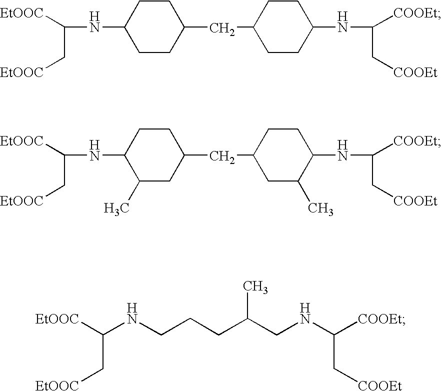
and mixtures thereof.

8. The method of claim 1 wherein the second part further comprises at least one aromatic polyamine, secondary aliphatic polyamine, or mixture thereof.

9. The method of claim 8 wherein the second part further comprises at least one aromatic polyamine that is a solid at 25° C.

10. The method according to claim 1 wherein the first part of the liquid coating system comprises a derivative of hexamethylene diisocyanate.

11. The method of claim 1 wherein the liquid mixture is heated and applied with spray equipment.

12. The method of claim 1 wherein the mixture has a set time of about 2 to 5 minutes.

13. The method of claim 1 wherein the cured coating has a tensile strength of at least 15 MPa as measured according to BS EN ISO 527:1996.

14. The method of claim 1 wherein the cured coating has an elongation of at least 50% as measured according to BS EN ISO 527:1996.

15. The method of claim 1 wherein the cured coating forms a continuous lining on the internal surface of the pipeline.

16. The method of claim 13 wherein the lining remains continuous upon a circumferential fracture forming in the pipe.

17. The method of claim 1 wherein the pipeline is buried underground at the time the coating composition is provided.

18. A method of forming a lining on a surface of a pipeline comprising the steps of:
a) providing a coating composition by combining
a first part comprises at least one polyisocyanate, and
a second part comprising at least one polyamine;
wherein the coating has a set time of 2 to 5 minutes;
b) combining the first part and the second part to form a liquid mixture;
c) applying the liquid mixture to internal surfaces of the pipeline having a diameter of less than 50 mm for a length of at least 5 meters; and
d) allowing the mixture to cure forming a cured continuous lining.

19. The method of claim 18 wherein the coating is applied for a length of at least 20 meters before the coating has set.

20. A reactive two-part coating composition, comprising:
a first part comprising at least one polyisocyanate; and
a second part comprising at least one aspartic acid ester and at least one aromatic amine that is a solid at 25° C.

21. The reactive two-part coating composition of claim 18 wherein the aromatic amine is an alkyl aniline.

22. The reactive two-part coating composition of claim 19 wherein the aromatic amine is selected from the group consisting of 4,4′-methylenebis(2-isopropyl-6-methylaniline); 4,4′-methylenebis(2,6-diisopropylaniline); 4,4′-methylenebis(2-ethyl-6-methylaniline); and 4,4′-methylenebis(3-chloro-2,6-diethylaniline).

23. The reactive two-part coating composition claim 18 wherein the first part comprises an aliphatic polymeric polyisocyanate that is substantially free of isocyanate monomer.

24. The reactive two-part coating composition claim 21 wherein the aliphatic polymeric isocyanate is a derivative of hexamethylene diisocyanate.

25. The reactive two-part coating composition claim 18 wherein the aspartic acid ester has the general formula 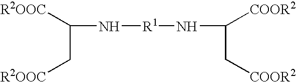
wherein R¹ is an aliphatic group comprising up to 20 carbon atoms, optionally comprising at least one cycloaliphatic group; and
each R¹ is independently a C1 to C4 aliphatic group.

26. The reactive two-part coating composition claim 23 wherein the aspartic acid ester is selected from the group consisting of 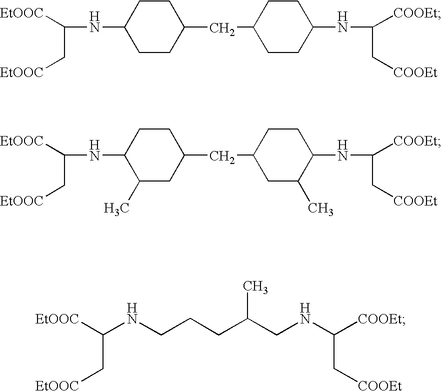
and mixtures thereof.
